(19) United States
(12) Patent Application Publication
(10) Pub. No.: US 2018/0113937 A1
(43) Pub. Date: Apr. 26, 2018

(54) DETERMINING PROCESS STEPS FROM ANALYSIS OF ONLINE COLLABORATIONS

(71) Applicant: INTERNATIONAL BUSINESS MACHINES CORPORATION, Armonk, NY (US)

(72) Inventors: THEMBANI TOGWE, LENEXA, KS (US); MICHAEL J. WHITNEY, CARY, NC (US)

(21) Appl. No.: 15/298,554

(22) Filed: Oct. 20, 2016

(51) Int. Cl. G06F 17/30; G06F 17/27

(52) U.S. Cl. CPC G06F 17/30864; H04L 65/403; G06F 17/30684; G06F 17/2765

(57) ABSTRACT

A computer-implemented method to determine process steps from analysis of online collaboration is provided. The method includes monitoring, by a processing unit, a collaboration session, and identifying a problem type from the collaboration session. The method also includes determining whether a record exists for a problem type in a process database, and generating a recommendation set of process steps for the collaboration type. The method includes determining a statement from the collaboration session defines a process step, identifying an action phrase in the statement, responsive to identifying the action phrase, identifying an activity phrase in the statement, and responsive to identifying the action phrase and the activity phrase, identifying an object phrase. The method also includes updating the process database by storing the process step for the identified problem type defined by the action phrase, activity phrase, and object phrase in the process database.

### BACKGROUND

The present invention relates to problem resolution, and more specifically, to determining process steps from analysis of online collaborations.

In today's environment, online collaborations are commonly used in personal and enterprise settings. Online collaborations provide an opportunity for several members to exchange ideas in real-time. Online collaborations can provide various services using different applications including teleconferences, web conferences, chat sessions, and the like. Online collaborations provide an array of features such as speech-to-text capability, text-to-speech capability, video capability, media sharing capability, and more. Also, online collaborations allow members in various locations to contribute synchronously or asynchronously to a current session.

The topics and goals for online collaborations can be set by the conference participants. Various business organizations and enterprises can use online collaboration sessions to brainstorm new ideas and/or discuss current tasks and problems. Virtual collaborations also provide a platform for assembling information from members who may have experience and expertise to aid in achieving a common goal.

### SUMMARY

According to an embodiment of the present invention, a computer-implemented method for determining process steps from analysis of online collaborations is provided. The method includes monitoring a collaboration session and identifying a problem type from the collaboration session. The method also includes determining whether a record exists for a problem or concept type in a process database and generating a recommendation set of process steps for the problem or concept type. The method includes determining a statement from the collaboration session defines a process step, identifying an action phrase in the statement, responsive to identifying the action phrase, identifying an activity phrase in the statement, and responsive to identifying the action phrase and the activity phrase, identifying an object phrase. The method also includes updating the process database by storing the process step for the identified problem type defined by the action phrase, activity phrase, and object phrase in the process database.

According to an embodiment, a system for determining process steps from analysis of online collaborations is provided. The system includes a memory coupled to a processor and a processing engine configured to monitor a collaboration session, and identify a problem type from a statement of the collaboration session. The system also determines whether a record exists for the problem type in a process database, and generates a recommendation set of process steps for the problem type. The system determines a statement from the collaboration session defines a process step, identifies an action phrase in the statement, responsive to identifying the action phrase, identifies an activity phrase in the statement, and responsive to identifying the action phrase and the activity phrase, identifies an object phrase. The system also updates the process database by storing the process step for the identified problem type defined by the action phrase, activity phrase, and object phrase in the process database.

In accordance with a different embodiment, a computer program product for determining process steps from analysis of online collaborations is provided. The computer program product includes a computer readable storage medium having stored thereon program instructions executable by a processor to cause the processor to monitor a collaboration session, and identify a problem type from a statement of the collaboration session. The program instructions are further executable by a processor to cause the processor to determine whether a record exists for the problem type in a process database, and generate a recommendation set of process steps for the problem type. The program instructions are further executable by a processor to cause the processor to determine a statement from the collaboration session defines a process step, identify an action phrase in the statement, responsive to identifying the action phrase, identifying an activity phrase in the statement, and responsive to identifying the action phrase and the activity phrase, identify an object phrase. The system also updates the process database by storing the process step for the identified problem type defined by the action phrase, activity phrase, and object phrase in the process database.

### BRIEF DESCRIPTION OF THE DRAWINGS

FIG. 1 is a block diagram illustrating one example of a processing system for practice of the teachings herein;

FIG. 2 illustrates a flow diagram of a method for determining process steps from analysis of online collaborations in accordance with an embodiment;

FIG. 3 illustrates a flow diagram of a method for determining process steps from analysis of online collaborations in accordance with an embodiment;

FIG. 4 illustrates a table for determining process steps from analysis of online collaborations in accordance with an embodiment; and

FIG. 5 illustrates a table for determining process steps from analysis of online collaborations table in accordance with another embodiment.

### DETAILED DESCRIPTION

Online collaborations allow for the free exchange of ideas through a communication application. In an embodiment, the system analyzes the unstructured exchange of information in the virtual collaboration and develops a knowledge base for solving commonly encountered problems. During a subsequent collaboration, if a record for a known or related problem exists in the knowledge base, recommendations can be provided for resolving the issue based on the record. If a record for the identified problem does not exist in the knowledge base, the knowledge base can begin to record and develop information for solving the identified problem. As more and more collaborations are analyzed and more data points are obtained, the problem solving procedure can be optimized by updating the recorded procedures. The text analysis of the collaboration performed by the system aids a user in determining the process steps for solving the problem. These recorded procedures can be promoted to preferred enterprise wide protocols.

The knowledge base can be used to not only determine problem steps for solving issues, but it can also be leveraged to determine an efficient sequence to implement the process steps. A scoring algorithm can be used to optimize the knowledge base for solving similar types of problems. Recommendations can be developed for the users based on the scoring algorithms, sequencing of process steps, and the previously monitored collaborations.

As more problem types for a task are recorded, an optimal set of process steps for resolving problems will be realized. A clear representation for solving a particular problem type can be determined and these procedures can be elevated to preferred enterprise wide protocols. In an embodiment, in a telemedicine collaboration between healthcare practitioners and/or patients, a knowledge base can be developed in accordance with the teachings herein. The knowledge base can then be subsequently leveraged by other healthcare practitioners based on the protocols followed for the related conditions and identified problem types.

In one or more embodiments, the development of a process database increases the efficiency of resolving common problems by maintaining information related to best practices as employees or individuals having knowledge of the best practices become unavailable. The information from the developed process database can be leveraged to determine an efficient method for attacking the identified issue.

Problem types can be determined from the source of the collaboration messages, attached media, transcribed audio and other artifacts included in the collaboration stream. In an example, cognitive systems are being trained to recognize cancer cells from analyzed images, where problems types can be recognized from the analyzed images. In one or more embodiments, the user can provide the problem type. In another embodiment, if an action phrase is not determined from the present statement, a search for the activity phrase and object phrase will not be triggered, and the analysis of the next statement will be performed. When an action phrase is matched, then the system will continue to look for further information for a process step. This information includes activity phrases and object phrases. In one or more embodiments, a cognitive application program interface API can allow for concept matching, which can mimic the human brain by recognizing concept relationships as well as specific relationships.

In one or more embodiments, the problem type can be determined from the spontaneous conversation of a collaboration based on the context of the discussion of the current collaboration. In other embodiments, a consensus of the problem type can be determined by an acknowledgment of such a problem by a conference participant. In a different embodiment, a problem type can be triggered by an event such as determining a performance threshold has been violated or is trending negatively.

In another embodiment, the problem type can be determined from the source of the conversation. In one example, the business units or departments of an enterprise can be identified in the collaboration where respective business units or departments are associated with common problem types. For example, a supply chain business unit may be faced with delayed order and/or parts shortages. In another example, in a telemedicine environment if an oncology department is collaborating with a gastroenterology department in an online collaboration session, there is an increased probability the problem type is related to stomach cancer based on the department types that are communicating. Oncology departments generally deal with issues involving cancer while gastroenterologists deal with stomach issues. In a different example, an order management department may deal with parts exchange/returns and/or customer satisfaction issues. A delivery business unit may commonly deal with supply chain disruption and/or weather events. These examples are non-limiting and are only provided for illustrative purposes.

Groups or teams of people including artificially intelligent participants can meet up together virtually to work together in pursuit of a shared task, goal, or problem. In an example, cognitive systems, such as those including artificially intelligent participants, are being trained to participate as advisors across a wide variety of problem types and professions. Often these groups or teams are working through an unknown, undocumented, or not well understood set of tasks to collaboratively come to a successful outcome. When this is the case, a process or plan is not well understood before beginning the tasks, and it would benefit the people working together to solve a problem or complete a task to see some system generated information about how similar or related problems or tasks have been approached in the past.

The technique described herein provides an online social collaboration tool or platform can perform analysis of the recorded online collaboration interactions between people working together on a shared goal. Subsequently common process steps can be recorded in which can then be used to suggest processes or protocols in the future based on prior collaboration session.

Enterprise collaboration is improved by increasing the knowledge base for solving similar or related problems. A historical scoring process can reveal a best or accepted set and sequence of steps for resolving an issue, based on the frequency of the issue occurring. In addition, this technique provides recommendations for specific steps on solving an issue. The problem solving method can be automated for determining a set and sequence of steps. This technique allows for the learning, tasks and problems will be resolved quicker and more effectively each time a similar or related problem is solved and recorded. The techniques described herein allows for crowd sourcing of best practices for processes and these processes can be promoted to the standard set of practices or accepted protocols.

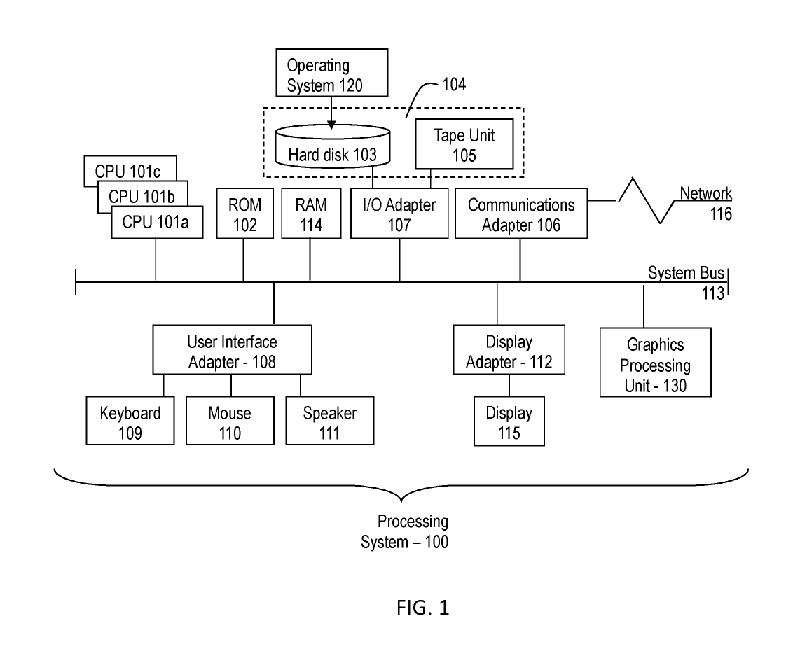

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

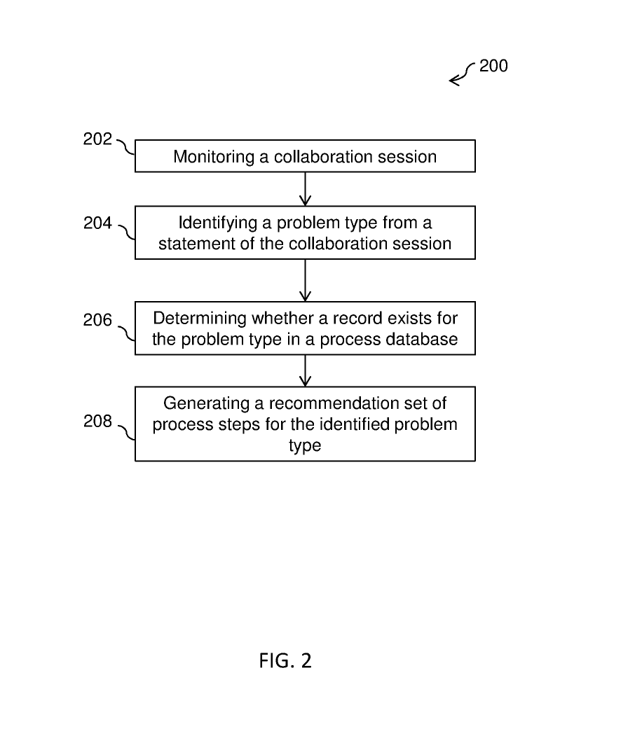

Now referring to FIG. 2, a flow diagram 200 for determining process steps from analysis of online collaborations is provided. Block 202 provides monitoring, by a processing unit, a collaboration session. Collaboration sessions include non-real-time communications such as a series of emails, recorded teleconference transcripts, closed chat sessions, and the like. Collaborations can also include real-time chat sessions, web conferences, and the like. In other embodiments, collaborations can be analyzed in real-time and the past collaboration sessions can be analyzed after the close of the session.

Block 204 includes identifying a problem type from a statement of the collaboration session. In an embodiment, problem types can include delayed orders, part shortages, order modifications, etc. In one or more embodiments, the problem type can be automatically identified by the system or can be identified by a user. In one or more embodiments, the system can prompt the user based on the context of the conversation of the collaboration of a certain issue or problem that is being solved in the collaboration. In an example, a business enterprise for a supply chain may face common problems such as delayed orders, parts shortages, shipping delays, customer satisfaction, weather event, and the like, where the system can automatically identify the problem type from the collaboration sessions. In another example, a user can be prompted whether a problem type exists based on the context of the collaboration sessions and the business enterprise type the user is associated with.

Block 206 includes determining, by the processing unit, whether a record exists for the problem type in a process database. In an embodiment, the problem type identified from the statement of the current collaboration can be searched in the process database. If the problem type does not exist in the process database, the process database can be updated to add the new problem type identified in the current collaboration and begin adding process steps for resolving the newly identified problem type.

Block 208 provides generating, by the processing unit, a recommendation set of process steps for the identified problem type. In an embodiment, a recommendation set associated with identified problem type can be presented to the user in a variety of ways. For example, if the system identifies a problem type from the current collaboration, a set of process steps that are commonly used for solving the problem can be provided to the participants. In a different embodiment, the system can determine from the context of the current collaboration a problem type to be solved and determine the collaboration participants are in the process of solving the issue. In this scenario, the system can propose a next process step for resolving the issue based on the process steps in the process database for the problem type. In an embodiment, an ordered sequence of a set of process steps can be proposed to the user. After the recommendation set is determined the recommendation set can be transmitted to the user or participant of the collaboration session.

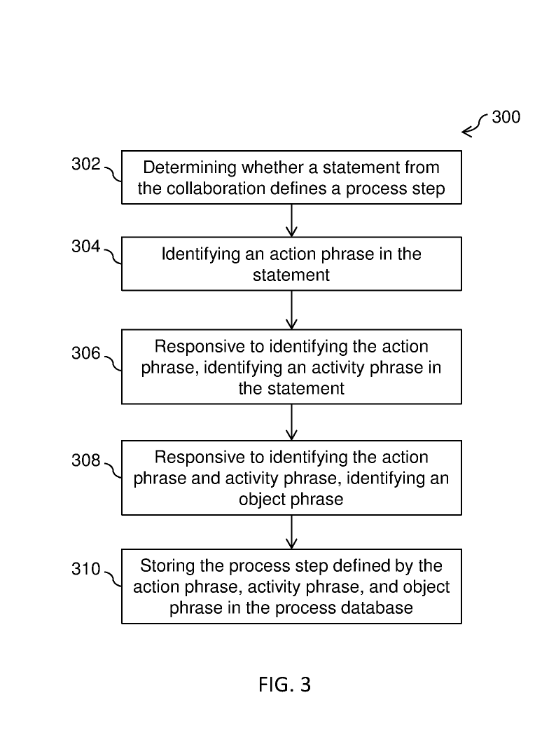

With reference now to FIG. 3, a flow diagram 300 in accordance with an embodiment is shown. Block 302 provides determining whether a statement defines a process step. In an embodiment, statements of a collaboration session are analyzed to determine a problem type and a process step for the problem type. After the determination, the problem type and process step information can be stored and indexed in the process database.

As shown in block 304, a step of identifying an action phrase in the statement is shown. In one or more embodiments, action phrases include such terms but not limited to should, will have, going to, please, try to, got, found, determined, learned, etc. In an embodiment, if an action phrase is found a search for an activity phrase will be performed.

Block 306 provides responsive to identifying the action phrase, identifying an activity phrase in the statement. Activity phrases include such terms as, in a non-limiting example, call, expedite, email, look up, talk, find, calculate, get together, research, check into, etc.

Block 308 provides responsive to identifying the action phrase and activity phrase, identifying an object phrase. Object phrases include such terms in a non-limiting example, stock, customer, order, manager, staff, administrator, etc.

Block 310 provides storing the process step defined by the action phrase, activity phrase, and object phrase in the process database. In an embodiment, as each process step is identified from the various collaborations the process steps are stored and categorized for each problem type to the process database.

In one or more embodiments, a process database can be preconfigured with data identified by the enterprise, organization, or website/application. In an embodiment, the process database for action, activity, and object phrases that are related to the enterprise can be pre-configured or developed in real-time.

In one or more embodiments, the process database is generated from monitoring online collaborations. In a different embodiment, the process database can be developed by a combination of preconfigured information and monitoring online collaboration sessions.

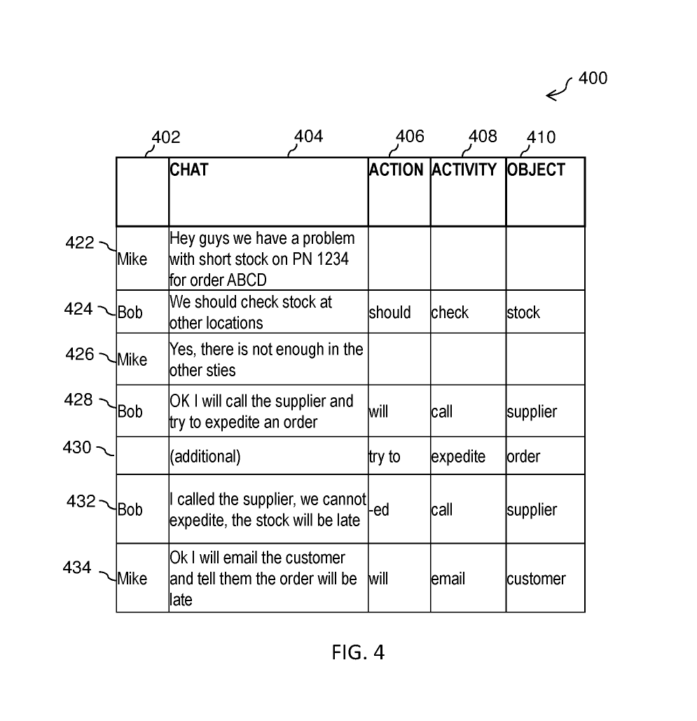

While analyzing a collaboration session, the problem type will be determined. As an example, a problem type can be related to a problem associated with an enterprise. Now referring to FIG. 4, a table 400 is provided for the following sample collaboration session:

1) Mike: Hey guys we have a problem with short stock on PN 1234 for order ABCD

2) Bob: We should check stock at other locations

3) Mike: Yes, there is not enough in the other sites

4) Bob: OK I will call the supplier and try to expedite an order

5) Bob: I called the supplier, we cannot expedite, the stock will be late

6) Mike: Ok I will email the customer and tell them the order will be late

Column 402 provides the names of the participants in the collaboration. Column 404 provides the statements that were made during the collaboration session. Column 406 provides an action phrase, column 408 provides an activity phrase, and column 410 provides an object phrase obtained from the collaboration session.

Row 422 provides an analysis of statement (1) from the sample collaboration transcript. Statement (1) does not include an action phrase, activity phrase, or object phrase. However statement (1) identifies a problem type from the statement. Based on the analysis the problem type is identified as a “part shortage.”

Row 424 shows the analysis for statement (2) and identifies the action phrase “should,” the activity phrase “check,” and the object phrase “stock.”

Row 426 shows the analysis for statement (3) does not identify an action phrase, activity phrase, or object phrase.

Row 428 shows the analysis for statement (4) and identifies the action phrase “will,” the activity phrase “call,” and the object phrase “supplier.” Row 430 identifies the action phrase “try to,” the activity phrase “expedite,” and the object phrase “order” for statement (4).

Row 432 shows the analysis for statement (5) and identifies the action phrase “-ed,” the activity phrase “call,” and the object phrase “supplier.”

Row 434 shows the analysis for statement (6) and identifies the action phrase “will,” the activity phrase “email,” and the object phrase “customer.”

During the analysis of a collaboration session, a line-by-line analysis is performed. Responsive to finding a combination of action phrases, activity phrases, and object phrases, a process step is generated and added to the processor database for the problem type. In an embodiment, each statement of the collaboration session is analyzed and the statements meeting the criteria above are recorded in the process database. In one or more embodiments, the process steps are recorded in the process database in the order of appearance of the statements in the collaboration for the problem type.

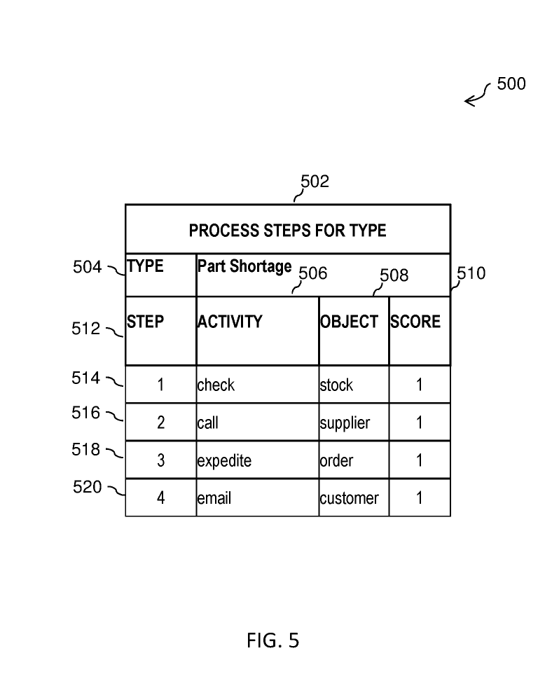

FIG. 5 provides a table 500 illustrating information stored in a processing database. Block 502 provides the table 500 includes process step for a particular problem type. In one or more embodiments, the process database can store one or more types. The type 504 for processing type is for a “parts shortage.” In an embodiment, a part shortage can be a common issue among businesses that manage inventory so common tasks may include checking on the status of parts, calling suppliers, having parts rushed, or communicating through email.

The process database includes one or more process steps 512 which can be provided to a user in sequence, which is in a particular order for resolving the part shortage issue. For each process, an activity phrase 506, object phrase 508, and score 510 is maintained in the process database. Row 514 provides the first process step includes the activity phrase “check” and the object phrase “stock.” The score “1” indicates that the process step has only been recorded once.

Row 516 provides a second recorded process step for the problem type “part shortage” includes an activity “call,” an object “supplier,” and a score of “1.” Row 518 provides a third step includes an activity “expedite,” an object “order,” and a score of “1.” Row 520 provides a fourth step includes an activity “email,” an object “customer,” and a score of “1.” The above analysis provided in table 500 is based on the table of FIG. 4.

In one or more embodiments, after the system has monitored several collaboration conversations the knowledge base for problem solving can be enhanced. As the number of collaborations being monitored increase and the information for solving different problem types increase, the process steps recorded for each problem type can be optimized. Process steps can be added and/or removed based and the sequence of the problem steps can be reversed and or changed.

In one or more embodiments, when a problem type from a current collaboration matches a problem type of the process database, a recommendation set of process steps can be provided for solving the identified problem type. In an embodiment, responsive to finding a statement in a monitored collaboration indicates a known problem type is being discussed, the system can provide a recommendation set of process steps from the process database to the user. The user can receive a task/check list that has been developed in the process database or can be provided the next recommended best steps based on the problem type.

In one or more embodiments, as collaboration sessions are continuously monitored by the system the process steps that have been recorded for the problem types can be modified based on current and past collaborations. In an embodiment, the updating of the process steps includes adding or removing process steps associated with the problem type. In another embodiment, the sequence of process steps can be modified based on the monitored collaborations. For example, a pair of process steps can be reversed or can be re-ordered altogether.

In one or more embodiments, a score can be associated with each process step that is stored in the process database as shown in FIG. 5. Each time a subsequent collaboration is monitored by the system and a process step for a problem type appears in the collaboration, the score in the process database for each process step can be incremented. Higher scores for process steps can indicate the process step is commonly performed when solving the identified problem type. In an embodiment, process steps that exceed a configurable threshold score are added to the recommendation set or accepted protocol. In one or more embodiments, process steps that fail to reach the configurable threshold score will not become part of the recommendation set or accepted protocol of process steps and will not be listed as part of a task/check list until the threshold is reached.

In one or more embodiments, process steps for a problem type that are recorded in the process database can be removed responsive to subsequently monitoring a plurality of different collaboration sessions where the process step is omitted from or not included in the monitored collaboration sessions. In another embodiment, the process step can remain in the process database but be removed from the recommendation set provided to users.

In a different embodiment, when a sequence of process steps occur in a particular order in multiple collaboration sessions, the score for the process steps can be increased. In an embodiment, the score can be increased by a higher weight when the process steps occur in a specific order to strengthen the relationship of the sequence of the process steps. In an example, instead of incrementing the score by 1 for each occurrence in the collaboration, the score for the ordered process steps can be doubled or tripled to indicate the likelihood that the process steps should occur in a particular sequence. For example, a pair or triplet set of instructions that occur in sequence can be incremented by an increased score.

In one or more embodiments, the process steps can be flipped based on monitoring subsequent collaborations. If a threshold number of collaborations provide that a sequence of process steps occur in a different order than the sequence that has been previously recorded, the process steps can be reversed.

In one or more embodiments, a validation procedure can be used to validate process steps in the process database and/or validate process steps prior to adding them to the recommendation set. The validation can occur in a variety of ways. In an embodiment, a process step can be validated when a process step exceeds a configurable validation threshold. The configurable validation threshold can be a number of occurrences and/or a percentage of occurrences among a number of different collaborations. For example, a process step must appear fifteen (15) times in collaboration sessions identifying the problem type prior to being validated. In a different example, a process step must appear in 15% of all monitored collaborations identifying a problem type in order to be validated. In a different embodiment, users that are participating in a current collaboration session discussing an identified problem type can be prompted to confirm a process step is valid. The input received from the user can be used to validate the current process step and/or update the score for the process step.

In one or more embodiments, a sufficient number of collaboration sessions can be analyzed prior to adding process steps for a problem type to a recommendation set where the recommendation set will be provided to users. Similarly, after analyzing a sufficient number of collaborations sessions, process steps can be removed from a recommendation set. In one or more embodiments, a minimum threshold score can be set to drop non-repeating steps from the recommendation set and/or process database.

In one or more embodiments, recommendations can be provided to a user after identifying a match for a problem type from the statements of the collaboration to process steps stored in the process database for the problem type. A participant of the collaboration can be provided with process steps based on high scores for the identified problem type. In an example, process steps that exceed a threshold score can be added to the recommendation set.

In a different embodiment, if a statement from a present collaboration matches a process step for a problem type in the process database, one or more participants can be prompted with one or more recorded next steps from the process database. In an embodiment, the participant can acknowledge the next step is required and a score can be increased accordingly for the process step. A task list or checklist, including the recorded process steps, can be sent to a user based on identifying a problem type. For example, a user can receive a recommendation set of process steps for addressing a part shortage if it is identified from the current collaboration. In an embodiment, the participants can receive a recommendation set of process steps based on the high scoring process steps. In addition, the steps can be proposed in a specific order to the participants.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining process steps from analysis of online collaboration, the method comprises:
monitoring, by a processing unit, a collaboration session;
identifying, by the processing unit, a problem type from a statement of the collaboration session;
determining, by the processing unit, whether a record exists for the problem type in a process database; and
generating, by the processing unit, a recommendation set of process steps for the problem type.

2. The method of claim 1, comprises determining a statement from the collaboration session defines a process step;
identifying an action phrase in the statement;
responsive to identifying the action phrase, identifying an activity phrase in the statement;
responsive to identifying the action phrase and the activity phrase, identifying an object phrase; and
updating the process database by storing the process step for the identified problem type defined by the action phrase, activity phrase, and object phrase in the process database.

3. The method of claim 1, responsive to locating a record for the problem type in the process database and matching a process step from the collaboration session with a process step in the process database, incrementing a score associated with the process step,
otherwise creating a record for the problem type in the process database and adding the process step from the collaboration session to the problem type.

4. The method of claim 1, further comprising validating a process step for the problem type; and adding the process step for the problem type to the recommendation set.

5. The method of claim 3, wherein a process step for the problem type is added to the recommendation set when the score for the process step exceeds a configurable threshold.

6. The method of claim 1, the method further comprises increasing a weight of a score associated with process steps responsive to multiple process steps for a problem type appearing in a fixed sequence in different collaboration sessions.

7. The method of claim 1, responsive to monitoring a threshold number of different collaboration sessions identifying a problem type, decrementing a score for a process step omitted from the different collaboration sessions.

8. A system for determining process steps from analysis of online collaborations, the system comprises:
a memory coupled to a processor; and
a processing engine configured to:
monitor a collaboration session;
identify a problem type from a statement of the collaboration session;
determine whether a record exists for the problem type in a process database; and
generate a recommendation set of process steps for the problem type.

9. The system of claim 8, comprises the processing engine configured to determine a statement from the collaboration session defines a process step;
identify an action phrase in the statement;
responsive to identifying the action phrase, identify an activity phrase in the statement;
responsive to identifying the action phrase and the activity phrase, identify an object phrase; and
update the process database by storing the process step for the identified problem type defined by the action phrase, activity phrase, and object phrase in the process database.

10. The system of claim 8, responsive to locating a record for the problem type in the process database and matching a process step from the collaboration session with a process step in the process database, incrementing a score associated with the process step,
otherwise creating a record for the problem type in the process database and adding the process step from the collaboration session to the problem type.

11. The system of claim 8, further comprising validating a process step for the problem type; and
adding the process step for the problem type to the recommendation set.

12. The system of claim 10, wherein a process step for the problem type is added to the recommendation set when the score for the process step exceeds a configurable threshold.

13. The system of claim 8, wherein increasing a weight of a score responsive to multiple process steps for the problem type appear in a fixed sequence.

14. The system of claim 8, responsive to monitoring a threshold number of different collaboration sessions identifying a collaboration type, decrement a score for a process step not appearing in the different collaboration sessions.

15. A computer program product for determining process steps from analysis of online collaborations, the computer program product comprising:
a computer readable storage medium having stored thereon program instructions executable by a processor to cause the processor to:
monitor a collaboration session;
identify a problem type from a statement of the collaboration session;
determine whether a record exists for the problem type in a process database; and
generate a recommendation set of process steps for the problem type.

16. The computer program product of claim 15, wherein the program instructions are further executable by a processor to cause the processor to:
determine a statement from the collaboration session defines a process step;
identify an action phrase in the statement;
responsive to identifying the action phrase, identify an activity phrase in the statement;
responsive to identifying the action phrase and the activity phrase, identify an object phrase; and
update the process database by storing the process step for the identified problem type defined by the action phrase, activity phrase, and object phrase in the process database.

17. The computer program product of claim 15, wherein the program instructions are further executable by a processor to cause the processor to:
responsive to locating a record for the problem type in the process database and matching a process step from the collaboration session with a process step in the process database, increment a score associated with the process step,
otherwise creating a record for the problem type in the process database and adding the process step from the collaboration session to the problem type.

18. The computer program product of claim 15, wherein the program instructions are further executable by a processor to cause the processor to:
validate a process step for the problem type; and
add the process step for the problem type to the recommendation set.

19. The computer program product of claim 17, wherein a process step for the problem type is added to the recommendation set when the score for the process step exceeds a configurable threshold.

20. The computer program product of claim 15, wherein the program instructions are further executable by a processor to cause the processor to:
responsive to monitoring a threshold number of different collaboration sessions identifying a problem type, decrement a score for a process step not appearing in the different collaboration sessions.
